(19) United States
(12) Patent Application Publication
(10) Pub. No.: US 2004/0186781 A1
(43) Pub. Date: Sep. 23, 2004

(54) Verification protocol for a point of sale merchandising system

(76) Inventors: Alan L. Swain, Richmond (CA); Kevin K. M. Woo, Surrey (CA)

Correspondence Address: OGILVY RENAULT, 1981 MCGILL COLLEGE AVENUE, SUITE 1600, MONTREAL, QC, H3A2Y3, CA

(21) Appl. No.: 10/389,808

(22) Filed: Mar. 18, 2003

(51) Int. Cl. G06F 17/60

(52) U.S. Cl. 705/15

(57) ABSTRACT

A method of validating a merchant in a point of sale transaction system, comprising the steps of encrypting a customer secret identification information using a public key of the merchant, entering the encrypted information into a transaction device, transmitting the encrypted information from the device to a merchant, decrypting at the merchant and the encrypted secret identification information, and transmitting the decrypted secret identification information from the merchant to the device wherein the customer verifies the decrypted secret identification information by visual inspection of the secret identification information.

The present invention relates to a remote electronic transaction system, and more particularly, to a point of sale system for validating the merchant and that merchant's payment acceptance method.

### BACKGROUND OF THE INVENTION

Point of sale systems (POS) have become almost universally adopted in various merchant systems. While traditional merchant systems require customers to be present at the merchant's premises, a wireless merchant system has mobile terminals that allows electronic payment to be made away from the merchant premises. This creates new business opportunities for the merchant. For example, Internet shopping with “payment at the door” opens new marketing channels with increased sales. We are all familiar with the delivery of pizza and other food stuffs ordered from a vendor by telephone and delivered to the customer's home where it is paid for by cash, credit or debit card payments.

A wireless merchant system typically comprises of one or more wireless POS terminals connected via a wireless network through a gateway to a financial transaction server (FTS), which is typically the merchant's bank and often referred to as the acquiring bank. One of the benefits of these wireless POS systems is that the customer is not always required to have cash on hand. Further, the POS system is normally integrated with the merchant's payment transaction server and allows various electronic reconciliation and reduction of paperwork for the merchant.

One of the disadvantages, however, of the traditional POS terminal is that it is relatively expensive, runs a proprietary protocol and has to be obtained from one of a limited number of suppliers.

These special POS terminals were developed out of necessity to ensure reliable communication between the terminal and the FTS and more importantly, to provide the customer with a degree of confidence that the exchange has been transacted with a legitimate merchant.

One solution which is proposed in order to lower the cost of traditional POS systems, is to utilize, instead of dedicated POS terminals, the use of inexpensive wireless devices, such as cellular telephones, PDAs and such like. One of the benefits of such device is that they are designed to operate over the relatively inexpensive wireless Internet infrastructure. Typically, these devices communicate using an open global standard for wireless Internet transmission such as the wireless application protocol (WAP). One factor which has mitigated against widespread adoption of WAP devices in POS systems has been the lack of trust of the these devices by consumers. Generally, these WAP devices do not have any form of branding to identify the merchant and may be prone to use by imposters and such like.

Accordingly there is a need for a point of sale system which is capable of allowing the use of WAP devices as POS terminals while providing a measure of validation to the consumer.

### SUMMARY OF THE INVENTION

In accordance with this invention, there is provided a method of validating a merchant in a point of sale transaction system, comprising the steps of:

(a) providing to a customer a point of sale device for receiving an encrypted customer secret identification information;

(b) transmitting said customer secret information from said POS device to a merchant system;

(c) decrypting at said merchant said customer secret identification information;

(d) transmitting said decrypted secret identification information from said merchant to said POS device wherein, said customer verifies said decrypted secret identification information by visual inspection of said secret identification information.

### BRIEF DESCRIPTION OF THE DRAWINGS

These and other features of the preferred embodiments of the invention will become more apparent in the following detailed description in which reference is made to the appended drawings wherein:

FIG. 1 is schematic diagram of a merchant payment system; and

FIG. 2 is a ladder diagram of reverse challenge-response protocol according to the present invention.

### DETAILED DESCRIPTION OF THE PREFERRED EMBODIMENTS

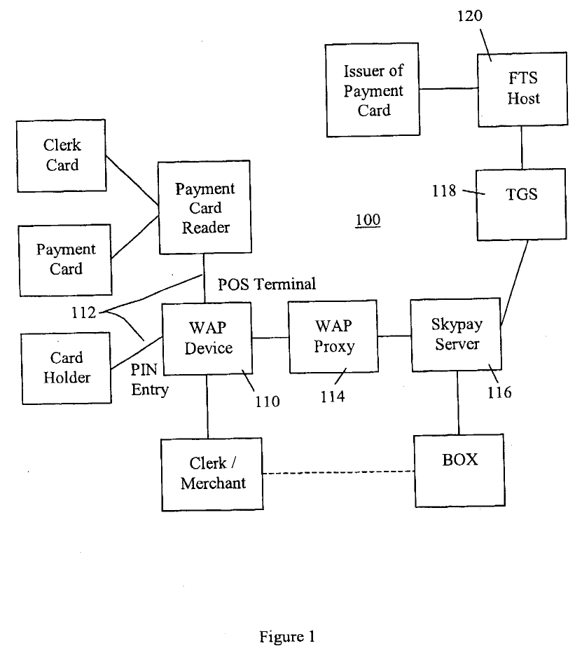

In the following, like numerals refer to like structures in the drawings. Referring to FIG. 1, there is shown a general reference model identifying the general components of a merchant payment system according to the present invention. The system 100 preferably includes at least one WAP enabled device 110 having a card reader, keypad 112 or other similar means for inputting information into the WAP device. The WAP device normally connects via a WAP proxy 114 to a server 116, which is in turn connected via a network to a transaction gateway server (TGS) 118. The transaction gateway server connects via a proprietary or dedicated network or other similar network to at least one financial transaction server (FTS) or payment gateway 120. In addition, the system 100 may also include an enterprise reporting subsystem (ERS) which includes a bank open exchange server (BOX) which is connected to the server 116 for receiving wireless POS transaction information. The box also receives information from the clerk or merchant from its POS terminals and possibly the WAP devices.

While traditional POS merchant systems relied on specialized wireless POS devices, the present system extends the functionality of these traditional systems to the use of common wireless devices that support a WAP environment. As identified earlier, existing systems presume that the payment system is a trusted system. However, by enabling a merchant to accept payment using a generic telephone such as a cell-phone, in conjunction with a customer PIN, it is important the customer has a level of trust in the device itself. Accordingly, in the present system, in order for a merchant to be able to accept smart card based payment from customers, the merchant first registers with an appropriate portal site. This site would define the merchant ID, the processing banks or processes, the merchants smart phone or wireless appliance type, the merchant's microbrowser type and version, network, network ID and ECR configuration. In use, when a merchant wants to accept payment from a customer, the merchant would begin by connecting to an application server by entering the appropriate URL in the microbrowser of the wireless appliance. A wireless connection will be made via a WAP proxy server, establishing a secure link to the application server. The application server will authenticate the merchant and recognize the merchant's WAP appliance type, browser type as well as the desired processor or bank and provide the appropriate WAP pages to facilitate the transaction. The set of WAP pages contains the user interface and may include intermediary calculations to complete the financial transaction request regardless of tender type.

Once the information gathering of the financial transaction is completed, the merchant device will request a customer's smart card for payment. This may be a smart card, a credit card, a debit card, a check card, a route to a client wallet server, or some other means of electronic payment. At this point, bidirectional authentication is required for the customer to be assured he is dealing with a valid merchant and a valid merchant payment acceptance system. The present invention provides for the cardholder to have a secret identification known only to the cardholder, which is encrypted using the application server's public key and which is stored on the card. The encrypted cardholder secret identification is sent to the application server. The application server knowing the originating device via the WAP will identify the merchant and allow for authentication of the merchant via an anchor portal site. Once this is done, the application server decrypts the cardholder secret identification received from the smart card and re-encrypts the cardholder secret identification via a standard WAP security protocol. This re-encrypted cardholder secret identification is then transmitted back to the merchant device.

On the merchant device, the customer will see a prompt such as “merchant authenticated by (Skypay Application Server) as evidenced by a secret code XYZ”.

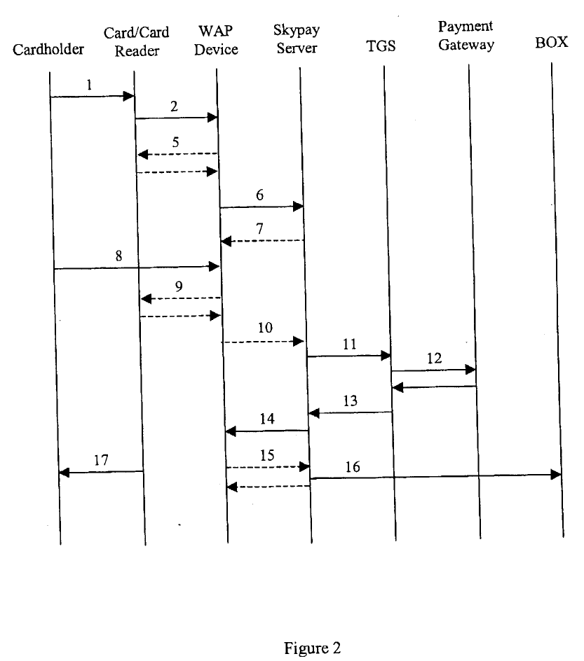

Referring to FIG. 2, there is shown a ladder diagram for an online credit card payment, according to an embodiment of the present invention. The sequence of message flow is as follows:

Firstly, it is assumed that as a precondition the clerk is registered on the system.

1. The Cardholder makes Card available to Card Reader;

2. The Clerk selects a URL to activate an online credit payment script which reads the card data;

3. The Script fills in an appropriate payment form, and presents the populated payment form in a browser;

4. The Clerk enters transaction details of the purchase into the payment form;

5. In the case of an IC Card transaction certain payment details are presented to the Card and the Card responds with an encrypted message of the payment details; otherwise the script generates a message authentication code (MAC);

6. The Transaction details are sent to the Server using an Online Credit Payment Request;

7. If the Server determines a PIN is required, it responds with a decoded Cardholder secret;

8. The Cardholder validates the decoded secret and if satisfied then enters PIN;

9. In the case of an IC Card transaction, the PIN is sent to the IC Card for encryption;

10. The PIN is sent to the Server;

11. The Transaction details are forward to the TGS;

12. The TGS performs the transaction via the Payment Gateway;

13. The Payment Center response is returned to the VT in the Server;

14. The VT issues a response to the browser in the WAP Device;

15. An Optional manual confirmation of receipt of the response is sent;

16. (assuming successful response from the TGS) payment details are sent to BOX after brief timeout Or manual confirmation; a correction record can be sent to BOX if there is no manual confirmation and the next transaction sequence id (cookie?) indicates the Payment Response was not received;

17. The Cardholder retrieves his/her Card and possibly a printed receipt.

By the customer visually (or audibly) verifying that the displayed secret is indeed the cardholder's secret known only to the customer, the customer can truly authenticate and trust the merchant and the application or merchant payment acceptance system that is being used by that now trusted merchant to accept and process the customer's payment. Thus, the customer enters a PIN or some other information such as biometrics into the WAP appliance to complete the financial transaction. At this point, the application server will construct the appropriate POS transaction and forward this transaction to the transaction gateway server. Details of the operation of a transaction gateway server is described in the Applicant's pending U.S. application Ser. No. 09/559,278 and incorporated herein by reference.

In a further embodiment, the secret could also be in the form of a spoke phrase. In this case, the customer would speak a certain phrase that would then be encrypted and sent across the communications link from the WAP appliance to the WAP server. Here the WAP server would decode the encrypted spoken phrase. The decrypted spoken phrase would then be fed into a voice recognition server. At one level, the particular phrase would result in a particular card holder secret being returned either in voice or alpha numeric form. At another level of authentication, a voice print could be done to uniquely associate the spoken phrase with the particular card holder secret. In this model, the card holder secret stored on the voice recognition server could be sent back via verbal confirmation or a text confirmation.

A further embodiment of the client cardholder secret may be as follows. The secret may be held in a client wallet server run by an issuing bank. A client wallet server is a holder of cardholder credentials run on behalf of the cardholder. To complete a payment transaction, a backend merchant system, perhaps a merchant wallet server (MWS) will initiate communications with the client wallet server, obtaining a cardholder's credentials. All commercial implementations of client wallet servers are run behind a financial institution's firewall. These implementations are concerned with bi-directional authentication of both the mobile device and the client wallet server. However, the client is not assured that the merchant entity asking for cardholder credentials is an authentic and trusted merchant or that the system being used by the merchant is an authentic and trusted system.

The MWS acting on behalf of the merchant, would process the payment transaction on behalf of the merchant. A payment transaction is triggered by a payment request from the merchant to the MWS. This MWS then requests cardholder credentials from a client wallet server and processes the payment transaction using those credentials to a financial host. Since the MWS holds the key used to encrypt the cardholder secret, this key is first encrypted with the MWS public key and passed through the backend system to the client wallet server. The client wallet server (or some system such as a client wallet secret server acting on behalf of the client wallet server), then decrypts the key used originally to encrypt the cardholder secret and then decrypts the actual cardholder secret and sends this back to the MWS via some secure method. The MWS then forwards this secret to the merchant payment acceptance system or to some other sytem owned by the cardholder (such as the cardholder's cell phone or home computer). Then the cardholder's secret is shown to the cardholder prior to the cardholder giving final authorization to proceed with the payment. In this way, the cardholder is assured that he/she is dealing with a trusted system and a trusted merchant prior to providing final authorization to proceed with the transaction as only a trusted merchant using a trusted system would have been able to disclose the cardholder secret to the cardholder.

It may be seen, that the present system provides a relatively simple and efficient method for the customer to authenticate the merchant. The present invention may be used to extend existing standards for electronic transactions such as SET. The SET standards specify secure means for electronic transactions. Specifically, they address the situation of a cardholder paying for goods from their home computer over the World Wide Web. There are two key assumptions, specifically, the home computer, is trusted by the cardholder and a magnetic stripe card account is used. On the other hand, the NV96 standards enhance SET for the use of IC cards or smart cards. Like SET, the EMV standard assumes that a trusted device, typically a home computer, is used for transactions. Accordingly, with the present invention, security concerns associated with the use of generic devices may be ameliorated with the use of IC cards in place of magnetic stripe cards.

Although the invention has been described with reference to certain specific embodiments, various modifications thereof will be apparent to those skilled in the art without departing from the spirit and scope of the invention as outlined in the claims appended hereto.

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. A method of validating a merchant and that merchant's payment acceptance system in a point of sale transaction system, comprising the steps of:
(a) encrypting a customer secret identification information using a public key of said merchant;
(b) entering said encrypted information into a transaction device;
(c) transmitting said encrypted information from said device to a merchant;
(d) decrypting at said merchant said encrypted secret identification information; and
(e) transmitting said decrypted secret identification information from said merchant to said device wherein, said customer verifies said decrypted secret identification information by visual inspection of said secret identification information.

2. A method as defined in claim 1, said decrypted information being encrypted before transmission to said transaction device.

3. A method as defined in claim 1, said transaction device being a wireless telephone.

4. A method as defined in claim 1, said transaction device being a personal digital assistant (PDA).

5. A method as defined in claim 1, said customer verifies said information by audible means.
